(19) United States
(12) Patent Application Publication
(10) Pub. No.: US 2007/0022461 A1
(43) Pub. Date: Jan. 25, 2007

(54) Auxiliary information processing system

(76) Inventor: Janghwan Lee, Westfield, IN (US)

Correspondence Address: THOMSON LICENSING INC., PATENT OPERATIONS, PO BOX 5312, PRINCETON, NJ, 08543-5312, US

(21) Appl. No.: 10/570,459

(22) PCT Filed: Aug. 31, 2004
(86) PCT No.: PCT/US04/28309

§ 371 Date: Mar. 2, 2006

Related U.S. Application Data
(60) Provisional application No. 60/500,443, filed on Sep. 5, 2003.

(51) Int. Cl. H04N 7/16; H04N 7/00; H04N 11/00

(52) U.S. Cl. 725/135; 725/136; 348/468

(57) ABSTRACT

A system and method is provided for switching between various VBI encoding standards of an MPEG2 digital television signal in order to obtain correct and virtually seamless VBI data. The decoded VBI data is then re-encoded into an NTSC video signal (24) for presentation to an NTSC display (26). The system and method utilizes valid user data (52) as defined in the MPEG2 video system specifications and the ATSC standard for switching among various VBI data encoding formats. In this manner, it is possible to reduce un-wanted switching and eliminate the loss of data for un-wanted switching.

This U.S. non-provisional patent application claims the benefit of and/or priority to U.S. provisional patent application ser. No. 60/500,443 filed Sep. 5, 2003 entitled “Auxiliary Information Processing System”, the entire contents of which is specifically incorporated herein by reference.

### BACKGROUND OF THE INVENTION

1. Field of the Invention

The present invention relates to a method and apparatus for processing digital television signals and, more particularly, to a method and apparatus for processing auxiliary information in digital television signals.

2. Background Information

Many television signals include auxiliary or ancillary information or data, i.e. information or data other than video programs or audio program information. Examples of such auxiliary information include closed caption data in the United States, program guide information, program subtitles, emergency messages, non-real time sampled video, and/or the like. This auxiliary or ancillary information or data may be collectively termed auxiliary information.

In analog television signals, auxiliary information is typically included in the signal during the vertical blanking interval (VBI) and, therefore, auxiliary information may also be referred to as “VBI data” or “VBI services” (collectively “VBI data”). The term VBI data is used even though in other types of television signals, such as digital television signals, the so-called VBI data may be provided via a particular stream of digital data packets rather than in a vertical blanking interval or particular time interval of the television signal.

With respect to certain television signals, such as digital television signals, it is necessary to decode VBI data from the digital bitstream and then re-encode the VBI data for presentation on an analog video output. With regard to digital television signals utilizing MPEG2 encoding, it may be necessary to decode VBI data from MPEG2 user data (i.e. MPEG2 compliant bitstream) among various different VBI data standards (e.g. ATSC, SCTE 20 and SCTE 21), and then to re-encode the VBI data as NTSC video for output to and/or use by an NTSC video display and/or component. Current digital television signal receivers are only able to decode one type of VBI data standard from an MPEG2 signal.

It is therefore evident from the above discussion that what is needed is a digital television signal receiver that is operable to decode VBI data in an MPEG2 compliant bitstream encoded by any one of a plurality of VBI data standards.

It is therefore evident from the above discussion that what is further needed is a digital television signal receiver that is operable to decode VBI data in an MPEG2 compliant bitstream encoded by any one of a plurality of VBI data standards and re-encode the decoded VBI data into an NTSC signal.

It is therefore evident from the above discussion that what is still further needed is a digital television signal receiver that is operable to decode VBI data in an MPEG2 compliant bitstream encoded by any one of a plurality of VBI data standards and re-encode the decoded VBI data into an NTSC signal without loosing VBI data.

These needs and others are accomplished through application of the principles of the subject invention and/or as embodied in one or more various methods, forms and/or systems such as are shown and/or described herein.

### SUMMARY OF THE INVENTION

A system and method for switching between various VBI encoding standards of an MPEG2 digital television signal obtains correct and virtually seamless VBI data. The decoded VBI data is then re-encoded into an NTSC video signal for presentation to an NTSC display. The system and method utilizes valid user data as defined in the MPEG2 video system specifications and the ATSC standard for switching among various VBI data encoding formats.

In one form, the present invention provides a method of decoding VBI data of an MPEG2 television signal. The method includes the steps of: (a) receiving an MPEG2 television signal; (b) decoding the MPEG2 television signal to obtain a video signal; (c) determining whether valid user data exists in the obtained video signal; (d) determining, if valid user data exists in the obtained video signal, a value of the valid user data; and (e) decoding VBI data of the video signal according to one of a plurality of VBI data encoding formats as determined by the value of the valid user data.

In another form, the present invention provides a method of decoding VBI data of an MPEG2 television signal. The method includes the steps of: (a) receiving an MPEG2 television signal; (b) obtaining video data from the MPEG2 television signal; (c) determining whether valid user data exists in the obtained video data; (d) determining, if valid user data exists in the obtained video data, a VBI data encoding format of the MPEG2 television signal; and (e) decoding VBI data existing in the video data in accordance with the determined VBI data encoding format.

In yet another form, the present invention provides a digital television signal receiver. The digital television signal receiver includes an MPEG2 decoder operable to obtain video data from a received MPEG2 television signal, a VBI data extractor connected to the MPEG2 decoder and operable to obtain VBI data from the obtained video data. a VBI data determinator connected to the VBI data extractor and operable to determine whether the obtained VBI data includes valid user data, a VBI data encoding determinator connected to the VBI data determinator and operable to determine a VBI encoding format of the VBI data, and a VBI data decoder connected to the VBI data encoding determinator and operable to decode the VBI data according to the determined VBI encoding format.

### BRIEF DESCRIPTION OF THE DRAWINGS

The above mentioned and other features and objects of this invention, and the manner of attaining them, will become more apparent an the invention itself will be better understood by reference to the following description of one embodiment of the invention taken in conjunction with the accompanying drawings, wherein:

FIG. 1 is a simplified block diagram of an exemplary digital television signal receiver in accordance with the principles of the subject invention;

FIG. 2 is a more detailed block diagram of an exemplary digital television signal receiver in accordance with the principles of the subject invention;

FIG. 3 is a flowchart of an exemplary manner of determining the VBI encoding standard in accordance with the principles of the subject invention;

FIG. 4 is a flowchart of one portion an exemplary manner of decoding the VBI data in accordance with the principles of the subject invention; and

FIG. 5 is a flowchart of another portion of the exemplary manner of decoding the VBI data in accordance with the principles of the subject invention.

Corresponding reference characters indicate corresponding parts throughout the several views. Although the drawings represent embodiments of the invention, the drawings are not necessarily to scale and certain features may be exaggerated in order to better illustrate and explain the present invention. The exemplification set out herein illustrates one embodiment of the invention, in one form, and such exemplification is not to be construed as limiting the scope of the invention in any manner.

### DESCRIPTION OF THE PREFERRED EMBODMENT(S)

The embodiment disclosed herein is not intended to be exhaustive or limit the invention to the precise form disclosed so that others skilled in the art may utilize its teaching.

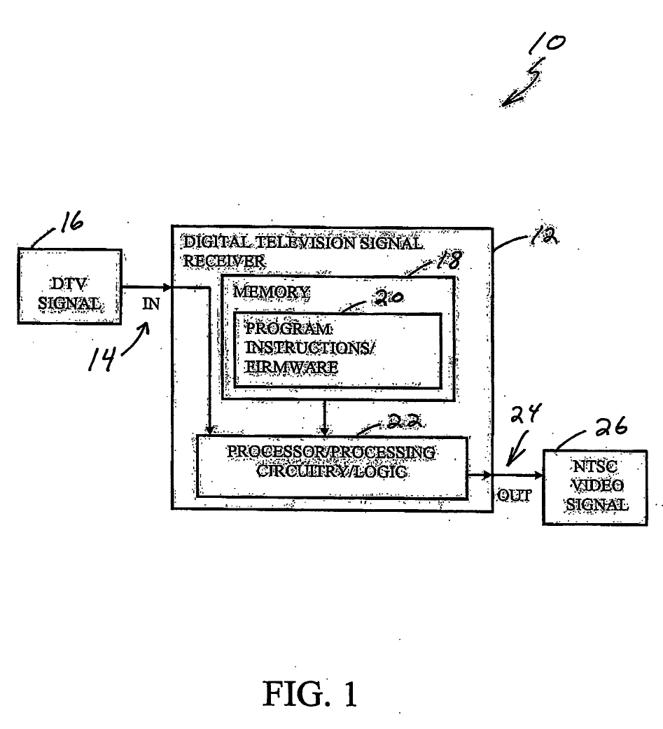

FIG. 1 depicts a block diagram of a system, generally designated 10, that receives a digital television signal, processes the digital television signal, and outputs an analog video signal all in accordance with the present principles. Particularly, system 10 is operable, configured and/or adapted to receive a digital television signal, process the digital television signal in the manner set forth herein, and output (provide) at least an NTSC video signal.

System 10 is characterized by a digital television signal receiver 12. Digital television signal receiver (DTSR) 12 is representative of any type of television signal receiver, such as a television, VCR, DVD, set top box, DVR, or the like, that utilizes digital television signals. While not discussed herein, digital television signal receiver 12 may also receive, process and/or utilize analog television signals in a manner such as is known in the art. Digital television signal receiver 12 includes an input 14 configured to receive a digital television signal 16. Digital television signal 16 may be provided by various sources such as via cable, satellite, terrestrial, or via another component. Digital television signal 16 may be in ATSC format, SCTE 20 format, SCTE 21 format, DVB (DVB-S, DVB-T, DVB-C) format and/or other formats. As such, digital television signal 16 is in MPEG2 compression format, but may be in other digital compression formats. Also, digital television signal 16 may include VBI information or data formatted according to the above format schemes. While not discussed herein, digital television signal 16 also includes audio information such as in AC-3 format (for ATSC signals) and MPEG2 format (for DVB signals).

Digital television signal receiver 12 includes memory 18 that may be of one or more various known forms of memory such as RAM, ROM, EEPROM, flash memory, or the like. Likewise, while not shown, memory 18 may be supplemented or take the form of data storage mediums such as hard drives or the like, all of which are collectively termed memory. Memory 18 stores program instructions, firmware, software or the like 20 (collectively, program instructions). Program instructions 20 are utilized by television signal receiver 12 and/or its various components for the operation of the various features, functions, capabilities and/or the like of television signal receiver 12 including the features and/or functions described herein in accordance with the principles of the present invention.

Digital television signal receiver 12 further includes a processor, processor or processing circuitry and/or logic generally designated 22 and collectively termed processing circuitry/logic. As such, processing circuitry/logic 22 may be embodied as one or more integrated circuits (chips) with or without additional circuitry and/or logic. The various components of processing circuitry/logic 22 may be under at least partial, if not total, control of the program instructions 20. Processing circuitry/logic 22 is operable,′ configured and/or adapted to process incoming digital television signal 16. Particularly, processing circuitry/logic 22 is operable, configured and/or adapted to receive and decompress/decode the MPEG2 bitstream (or other digital compression/coding scheme) of the incoming digital television signal 16, separate or parse the video and audio information/data thereof, and separate or parse any auxiliary (VBI) information therein. Additionally, processing circuitry/logic 22 is operable, configured and/or adapted to process the video and audio information in order to provide an appropriate audio output and to provide an appropriate video output. In this regard, processing circuitry/logic 22 is operative, configured and/or adapted to code the video information as NTSC video in order to provide an NTSC video signal 26 on video output 24 of the digital television receiver 12.

It should be appreciated that digital television signal receiver 12 also includes various other components that are not shown and/or described herein but are known in the art for practical utilization and/or operation thereof. Without being limiting or exhausting, such components include remote control devices, channel tuning devices, and/or the like.

In accordance with the principles of the subject invention, processing circuitry/logic 22 is further operable, configured and/or adapted to switch among various VBI information/data decoding algorithms for the various VBI encoding standards (e.g. ATSC, SCTE 20, SCTE 21) in order to properly obtain and decode the VBI data within the digital television signal. In this manner none to almost none of the VBI data is lost in the determination of the VBI data encoding standard used in digital television signal 16 for VBI decoding. This allows digital television receiver 12 properly decode the VBI data and then re-encode the VBI data into NTSC video signal 26. Briefly, processing circuitry/logic 22 uses or looks for a valid user data encoding parameter, syntax or semantic of a VBI encoding standard (e.g. valid user data as a valid user syntax) in accordance with a VBI data encoding standard for determining the VBI data decoding standard. Thus, once the VBI data is properly decoded, processing circuitry/logic 22 adds the VBI data to NTSC video signal 26 at video output 24.

It should be appreciated that the present invention is operable for various VBI encoding standards, but for exemplary purposes the present invention will be described with respect to the three most prevalent VBI encoding standards for digital television signals, i.e. ATSC (Advanced Television Systems Committee), SCTE 20 (Society of Cable Telecommunications Engineers—Standard Methods for Carriage of Closed Captions and Non-Real Time Sampled Video), and SCTE 21 (Society of Cable Telecommunications Engineers—Standard for Carriage of NTSC VBI Data in Cable Digital Transport Streams).

ATSC and SCTE 21 are similar except that SCTE 21 has extensions for new user data type code 4 and 5 that are for additional data and new luma data. Because of this, it is possible to discriminate SCTE 21 from ATSC using these user data type codes (i.e. from determining the presence of a particular VBI data syntax). With SCTE 20 and SCTE 21, however, there is a totally different data structure. Therefore, it is necessary to have a manner of determining and decoding SCTE 20 and SCTE 21. It is desirable to decide which format of data needs to be decoded and displayed on the screen and re-encoded for NTSC video output even if both can be decoded simultaneously because it may be undesirable to display both data formats at the same time on a screen. As well, it is not possible to encode two different VBI data for an NTSC output. Thus it is necessary to decide which format needs to be decoded, encoded and displayed. As described herein, the present system provides a manner to decide the current decoding format to use from among multiple formats of data.

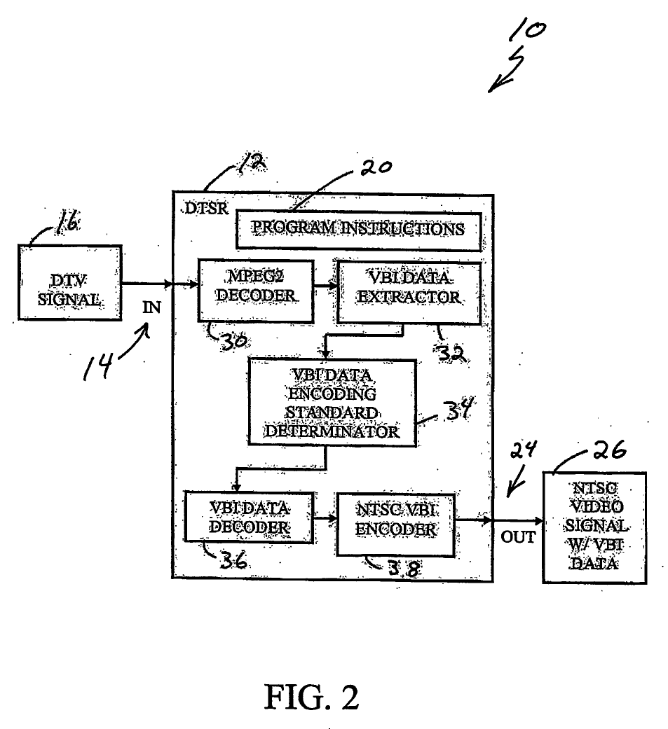

In FIG. 2, the functional portions of digital television receiver 12 of system 10 is shown particularly for switching the current decoding data format from among the several exemplary VBI encoding formats for MPEG2 digital television signals (e.g. ATSC, SCTE 20 and SCTE 21). Particularly, FIG. 2 depicts digital television signal receiver 12 with the functional blocks necessary to carrying out the principles of the subject invention. The program instructions 20 are included to indicate that the various components and/or processing is under at least the partial, if not total, control of the firmware, software or the like.

The digital television signal receiver 12 receives the digital television signal (DTV) 16 at the input 14.and proceeds to decode the MPEG2 DTV signal via an MPEG2 decoder 30. A VBI data extractor 32 is provided to extract VBI data from the MEPG2 signal that is operable to extract the VBI data from the MPEG2 signal. This is accomplished only if valid user data as defined by the ATSC standard is detected. A VBI data encoding standard determinator 34 is provided that is operable to determine the VBI data encoding standard from the extracted VBI data. While three exemplary formats are described (i.e. ATSC, SCTE 20, SCTE 21), it should be appreciated that other. formats may be supported.

A VBI data decoder 36 is provided that is operable to decode the VBI data extracted from the MPEG2 signal in accordance with the determined VBI data encoding standard. An NTSC VBI encoder 38 is further provided that is operable to encode the decoded VBI data from the MPEG2 signal into NTSC format. The NTSC encoded VBI data is then inserted into the NTSC video signal 26. The NTSC video signal 26 is provided at the output 24 of the digital television signal receiver 12.

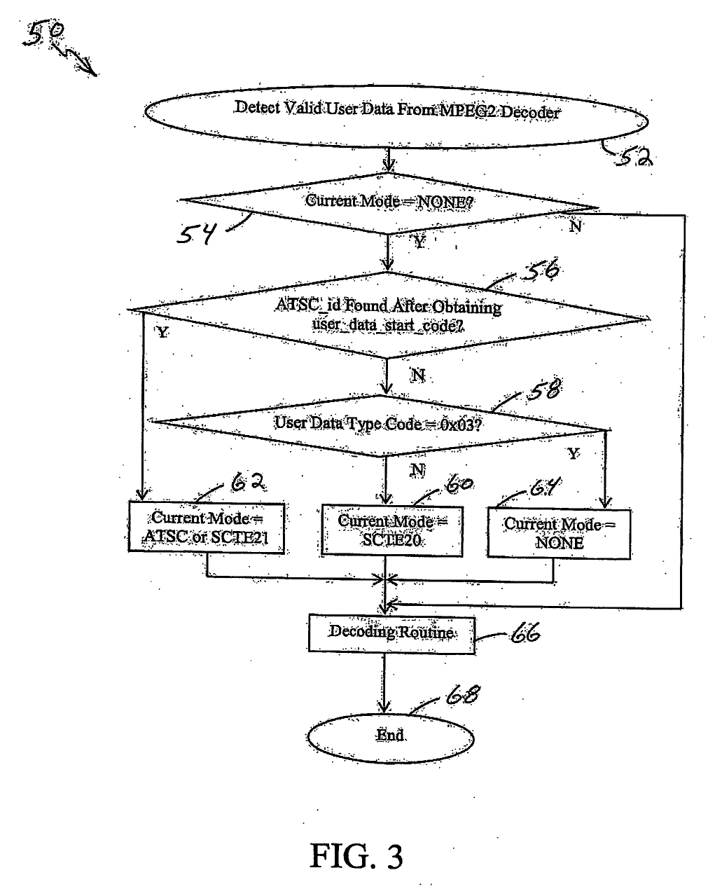

Referring now to FIG. 3, there is depicted a flowchart of an exemplary manner of operation, generally designated 50, of the present television. The operation of the system 10 begins with the detection of valid user data in an MPEG video stream 52. Thus, the operation depicted in FIG. 1 will be initiated whenever the system detects valid user data while decoding the MPEG2 video. In one form, valid user data is detected when the user₁₃ data₁₃ start₁₃ code as defined in the MEPG2 and/or ATSC standard is received (a user data parameter). Whenever valid user data is detected 52, the system begins decoding using the current mode for detecting valid data and the decoding process as presented in FIGS. 3, 4 and 5.

Once valid user data is detected 52, the system decides the decoding mode to which the system is currently set 54. If the current mode is not set to NONE (i.e. the decoding mode of the DTSR is set to one of the three decoding modes), then the determination at step 54 is NO (N) and the decoding routine 66 is initiated. This then ends the program flow of FIG. 3.

If however, it is determined that the current mode is not NONE (i.e. the decoding mode of the DTSR is set to one of the three decoding modes), then the system decides the decoding mode and will then assign the chosen value to the current mode if a valid data mode can be detected. Thus, if the determination step 54 is YES (Y) the system proceeds to decide the decoding mode. If a valid mode to decode is found, the system continues decoding until the system fails to decode for a particular time determined by a timer function identified as WaitTimer. The WaitTimer will be re-initialized whenever a valid VBI data is detected from user data. This means that it will be necessary to wait for switching to a new decoding mode after getting a valid data with current mode. Therefore, an alternative embodiment could involve starting with the current mode as NONE (default mode) when the system operation 50 begins. In that case, the system decides the current mode from the start.

Referring back to the system 50, the system then determines in step 56 whether the ATSC identification (ATSC_id) parameter is received after the user₁₃ data₁₃ start₁₃ code (another user data parameter) is obtained. If the ATSC₁₃ id has been received (i.e. Y for yes), then the current mode must be either ATSC or SCTE21. This data is stored for processing during the decoding routine 66. Program flow then goes to the decoding routine 66. Thereafter, the current program flow 50 ends 68.

If the ATSC₁₃ id has not been received (i.e. N for no), program flow goes to step 58. In step 58 the system determines whether user data type code 0x03 (another user data parameter) has been received. If the user data type code 0x03 has not been received (i.e. N for no), then the system in step 60 sets the current mode to SCTE20. If the user data type code 0x03 has been received (i.e. Y for yes), then the system in step 64 sets the current mode to NONE. After the system decoding mode has been set, the program goes to the decoding routine 66 and thereafter ends this routine 68.

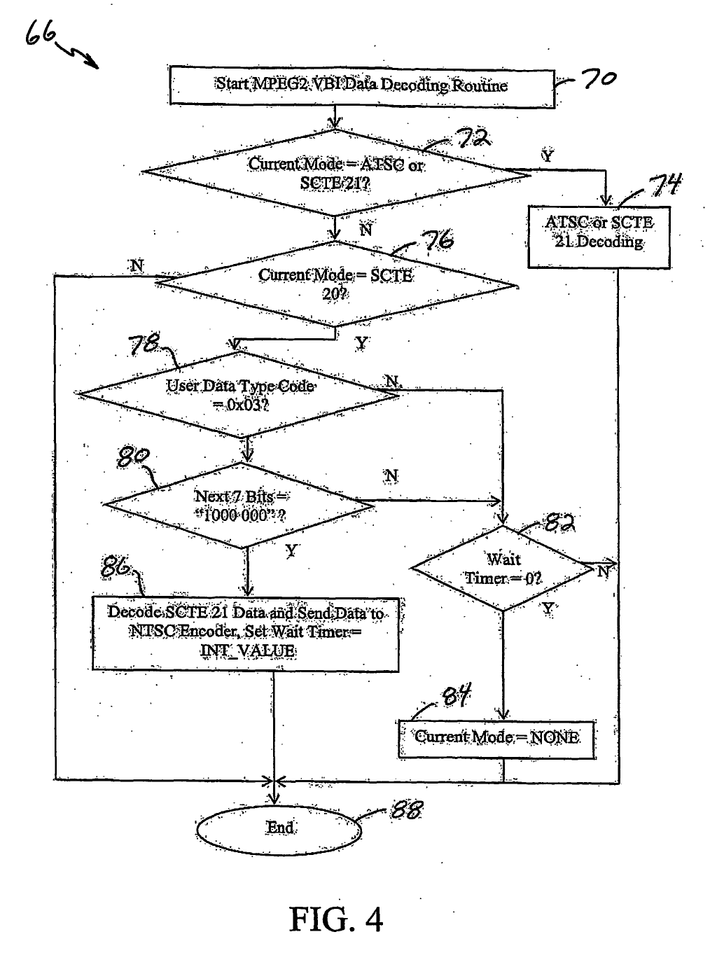

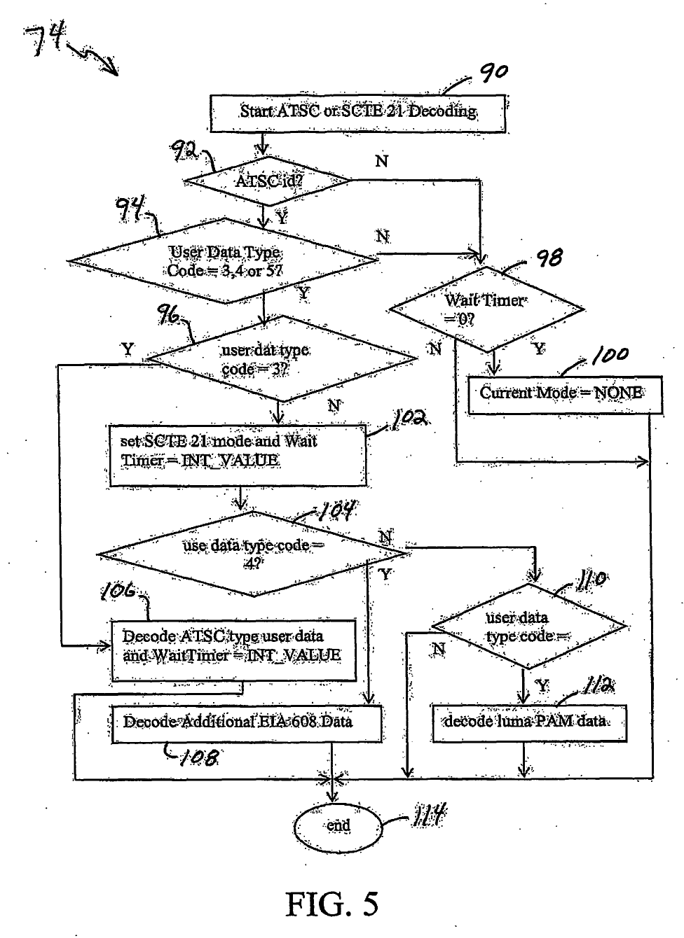

In FIG. 4, the decoding routine 66 is depicted. The decoding routine 66 begins with MPEG2 VBI data decoding routine start step 70. Thereafter, the system determines in step 72 whether the current mode has been set to either ATSC or SCTE 21. If the current mode is set to ATSC or SCTE 21 (i.e. Y for yes), then ATSC or SCTE 21 decoding routine 74 is invoked. This will be discussed in conjunction with FIG. 5 below. Thereafter, the routine 66 ends 88.

If the current mode in step 72 is not ATSC or SCTE 21 (i.e. N for no), then program flow proceeds to step 76 where it is determined whether the current mode is set to SCTE 20. If not (N for no), the system routine 66 ends and the system begins again to determine receipt of valid user data. If yes (Y), then program flow proceeds to step 78 where it is determined whether the user data type code 0x03 has been received. If the user data type code 0x03 has not been received (i.e. N for no), the program flow proceeds to step 82 where the WaitTimer setting is checked to determine if it is set to 0. If the WaitTimer is not set to 0 (i.e. N for no) then program flow ends 88. If the WaitTimer is set to 0 (i.e. Y for yes), then the system sets the current mode to NONE, step 84, and this routine ends 88.

If the user data type code 0x03 is received in step 78, then the system checks to determine whether the next seven bits received are “1000 000”. If not (N), then the WaitTimer is set to 0 (i.e. Y for yes), then the system sets the current mode to NONE, step 84, and this routine ends 88. If the next seven received bits are “1000 000” this signifies that the encoding format is SCTE21. Thus in step 86, the VBI data is decoded utilizing the SCTE21 decoding format. The decoded data is then sent to the NTSC encoder and the WaitTimer is set to INT_VALUE. Thereafter program 66 ends 88.

Referring to FIG. 5, the ATSC or SCTE 21 decoding routine 74 is depicted. The ATSC or SCTE 21 decoding routine 74 thus begins with step 90 initializing or starting the routine. Thereafter, it is determined whether ATSC₁₃ id has been received. If not, (N), then program flow proceeds to step 98 where the system then determines whether the WaitTimer is set to 0. If not (N), then routine 74 ends 114. If yes (Y), then the current mode is set to NONE, step 100, and routine 74 ends 114.

If ATSC₁₃ id has been received (Y), then the system in step 94 determines whether the user data type code is 3, 4 or 5. If not (N), then program flow proceeds to step 98 where the system then determines whether the WaitTimer is set to 0. If the WaitTimer is not (N) set to 0, then routine 74 ends 114. If WaitTimer is set to 0(i.e. yes, Y), then the current mode is set to NONE, step 100, and routine 74 ends 114.

If the ATSC₁₃ id is set to 3, 4 or 5, (Y), then the system determines in step 96 whether the user data type code is 3. If the user data code type is 3, then the ATSC encoding format is being used and program flow proceeds to step 106. In step 106, the VBI data is decoded using the ATSC decoding format and the WaitTimer is set to INT_VALUE. Thereafter decoding continues and the routine ends 114. If the user data type code is not 3 (N), then the system proceeds to step 102, wherein SCTh21 is set as the current mode and the WaitTimer is set to INT_VALUE.

Thereafter, the system determines in step 104, whether the user data type code =4. If not (N), the system proceeds to step 110. In step 110 it is determined whether the user type data code is 5. If not (N), the routine 74 ends 114. If yes (Y), then luma PAM data is decoded 112. If, however, in step 104, it is determined that the user type data code is 4 (Y), then additional EIA 608 standard data is decoded.

Another alternative embodiment for switching current decoding mode involves switching whenever a valid user data exists but valid VBI data cannot be obtained. As a result, it is possible to detect new format as valid user data and VBI data and, therefore, it is possible to avoid unnecessary switching while there is no data for a time period.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and that fall within the limits of the appended claims.

What is claimed is:

1. A method of decoding VBI data of an MPEG2 television signal comprising the steps of:
receiving an MPEG2 television signal;
decoding the MPEG2 television signal to obtain a video signal;
determining whether valid user data exists in the obtained video signal;
determining, if valid user data exists in the obtained video signal, a value of the valid user data; and
decoding VBI data of the video signal according to one of a plurality of VBI data encoding formats as determined by the value of the valid user data.

2. The method of claim 1, wherein the plurality of encoding formats comprise ATSC, SCTE20 and SCTE21.

3. The method of claim 1, wherein the valid user data comprises a start code.

4. The method of claim 3, wherein the start code comprises 0x000001B2.

5. The method of claim 1, further comprising the step of:
encoding the decoded VBI data of the video signal into an NTSC signal encoded from the obtained video data..

6. The method of claim 1, further comprising the step of:
continuing to decode the VBI data of the video signal until the system fails decoding for a predetermined period of time.

7. A method of decoding VBI data of an MPEG2 television signal comprising the steps of:
receiving an MPEG2 television signal;
obtaining video data from the MPEG2 television signal;
determining whether valid user data exists in the obtained video data;
determining, if valid user data exists in the obtained video data, a VBI data encoding format of the MPEG2 television signal; and
decoding VBI data existing in the video data in accordance with the determined VBI data encoding format.

8. The method of claim 7, further comprising the step of:
inserting the decoded VBI data into an NTSC video signal encoded from the obtained video data.

9. The method of claim 7, wherein the plurality of encoding formats comprise ATSC, SCTE20 and SCTE21.

10. The method of claim 7, wherein the valid user data comprises a start code.

11. The method of claim 10, wherein the start code comprises 0x000001B2.

12. The method of claim 7, further comprising the step of:
continuing to decode the VBI data of the video signal until the system fails decoding for a predetermined period of time.

13. A digital television signal receiver comprising:
an MPEG2 decoder operable to obtain video data from a received MPEG2 television signal;
a VBI data extractor connected to said MPEG2 decoder and operable to obtain VBI data from the obtained video data;
a VBI data determinator connected to said VBI data extractor and operable to determine whether the obtained VBI data includes valid user data;
a VBI data encoding determinator connected to said VBI data determinator and operable to determine a VBI encoding format of the VBI data; and
a VBI data decoder connected to said VBI data encoding determinator and operable to decode said VBI data according to the determined VBI encoding format.

14. The digital television signal receiver of claim 13, wherein the VBI data determinator is operable to determine the VBI encoding format from an ATSC, SCTE20 or SCTE21 encoding format.

15. The digital television signal receiver of claim 13, wherein the valid user data comprises a start code.

16. The digital television signal receiver of claim 15, wherein the start code comprises 0x000001B2.

17. The digital television signal receiver of claim 13, further comprising:
an NTSC encoder operable to insert the decoded VBI data into an NTSC video signal encoded from the obtained video data.
